(19) United States
(12) Patent Application Publication
(10) Pub. No.: US 2013/0154964 A1
(43) Pub. Date: Jun. 20, 2013

(54) TOUCH-SENSITIVE DISPLAY DEVICE AND METHOD FOR FABRICATING THE SAME

(71) Applicants: Pingping Huang, Sanming (CN); Yau-Chen Jiang, Zhubei (TW); Jinhai Zhang, Longyan (CN); Huilin Ye, Xiamen (CN)

(72) Inventors: Pingping Huang, Sanming (CN); Yau-Chen Jiang, Zhubei (TW); Jinhai Zhang, Longyan (CN); Huilin Ye, Xiamen (CN)

(21) Appl. No.: 13/569,159

(22) Filed: Aug. 7, 2012

(30) Foreign Application Priority Data
Dec. 17, 2011 (CN) 201110462772.3

(51) Int. Cl. G06F 3/041; B32B 37/12; B05D 5/00

(52) U.S. Cl. 345/173; 427/58; 156/292

(57) ABSTRACT

The present disclosure relates to a touch-sensitive device and a fabricating method thereof, and more particularly, to a touch-sensitive display device and the method for fabricating the same. The touch-sensitive display device including a display panel, a touch-sensitive panel, and a plurality of supporting bumps is located between the display panel and a touch-sensitive panel. The supporting bumps have elasticity to keep the touch-sensitive panel separated from the display panel.

### BACKGROUND OF THE INVENTION

This Application claims the benefit of the People's Republic of China Application No. 201110462772.3, filed on Dec. 17, 2011.

### FIELD OF THE INVENTION

The present disclosure relates to a touch-sensitive device and a method for fabricating the same, and more particularly, to a touch-sensitive display device and a method for fabricating the same.

### DESCRIPTION OF THE RELATED ART

Currently, many electronic devices such as smart phone, tablet computer, and laptop computer have adopted touch-sensitive display devices as their input and output device. Generally, a touch-sensitive display device is usually united by two pieces of plates, wherein one piece of plate is a touch-sensitive panel and the other piece is a display panel. Touch-sensitive panel is laminated with display panel by a adhesive layer, and touch-sensitive panel is above display panel. The light emitted from display panel pass through the touch-sensitive panel to present images to users.

When a touch-sensitive display device is not touched, there exists a gap between the touch-sensitive panel and the display panel. On the other hand, when a user touches the touch-sensitive panel, the panel is subjected to compression caused by the user to generate a deformation, which enables the touch-sensitive panel to contact the display surface, making them attract to each other. Even if the user stops the touching action, the two panels are still not able to separate from each other in a short time, which leads to incorrect appearance on the display surface, wherein the picture on the display surface has non-uniform colors, which usually is called as Mura phenomenon.

### SUMMARY OF THE INVENTION

The present disclosure is to provide a touch-sensitive display device, in which a plurality of supporting bumps are included to reduce the chance of emergence of pictures with non-uniform colors.

This disclosure is to provide a touch-sensitive display device, which comprises a display panel; a touch-sensitive panel disposed above the display panel; and a plurality of supporting bumps located between display panel and the touch-sensitive panel, wherein the supporting bumps have elasticity to keep the touch-sensitive panel and the display panel separated.

This disclosure is also to provide a fabricating method for a touch-sensitive display device, comprising the steps of: forming a plurality of supporting bumps between a display panel and a touch-sensitive panel, wherein the supporting bumps have elasticity to keep the touch-sensitive panel and the display panel separated.

In order to further understand the above mentioned features and technical contents, please refer to the following relevant detailed description and attached drawings, which are only taken for illustration and no limitation with regard to the right scope of this disclosure.

### BRIEF DESCRIPTION OF THE DRAWINGS

For those skilled in the art, numerous embodiments and drawings described below are for illustration purpose only and do not limit the scope of the present disclosure in any manner.

FIG. 1 is a cross-sectional schematic diagram of the touch-sensitive display device in accordance with an embodiment of the present disclosure.

FIG. 2 is a cross-sectional schematic diagram of the touch-sensitive display device of FIG. 1 while touch-sensitive panel is being subjected to oppression.

FIG. 3 is a flow-path schematic diagram of the fabricating method for the touch-sensitive display device in FIG. 1.

FIG. 4 is a cross-sectional schematic diagram of the touch-sensitive display device in accordance with another embodiment of the present disclosure.

### DETAILED DESCRIPTION OF THE EMBODIMENTS

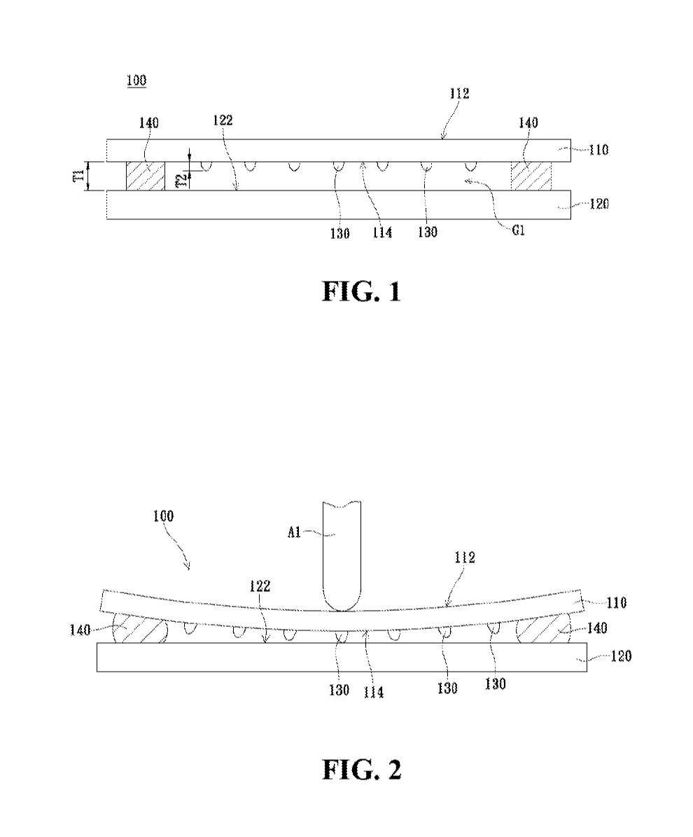

FIG. 1 is a cross-sectional schematic diagram of a touch-sensitive display device in accordance with an embodiment of the present disclosure. With reference to FIG. 1, the touch-sensitive display device 100 of this present embodiment comprises a touch-sensitive panel 110, a display panel 120, and several supporting bumps 130. The touch-sensitive panel 110 has a touch-sensitive surface 112 and a bottom surface 114 opposite to the touch-sensitive surface 112. The touch-sensitive panel 110 can be a capacitive touch-sensitive panel or a resistive touch-sensitive panel.

The display panel 120 has a display surface 122, while the touch-sensitive panel 110 is disposed above the display surface 122. The bottom surface 114 is located opposite to the display surface 122, i.e. the bottom surface 114 is located between the display surface 122 and the touch-sensitive surface 112. The images can appear on the display surface 122. When the display surface 122 presents images, a beam for forming images (not shown) is emitted from the display surface 122, which then passes through the touch-sensitive panel 110 from the bottom surface 114. Later, this beam is emitted from the touch-sensitive surface 112, making images to appear on the touch-sensitive surface 112.

In an embodiment, the display panel 120 can be a LCD panel. The touch-sensitive display device 100 can be a touch-sensitive LCD device. In addition, when the display panel 120 is a LCD panel, the display panel 120 can be combined with a backlight module (not shown) to form a LCD module, wherein the display panel 120 is located between the backlight module and the touch-sensitive panel 110. The display panel 120 also can be an Organic Light Emitting Diode (OLED) panel, but the type of display panel is not limited herein.

The supporting bumps 130 are located between the touch-sensitive panel 110 and the display panel 120, wherein the supporting bumps 130 can be disposed on the bottom surface 114 of the touch-sensitive panel 110. In an embodiment, supporting bumps 130 can be mutually isolated so as to not get in contact with each other.

In another embodiment, supporting bumps 130 can be transparent bumps, or non-transparent bumps.

In another embodiment, supporting bumps 130 can be formed through printing or coating. Moreover, the supporting bumps 130 can be made of a light sensitive material such as a photoresist material, allowing the supporting bumps 130 to be formed via developing. In addition, the material for the supporting bumps 130 can be ultraviolet solidified ink.

In another embodiment, touch-sensitive display device 100 can further comprise an adhesive layer 140. The adhesive layer 140 is located between the bottom surface 114 and the display surface 122. The adhesive layer 140 is applied to bond the display panel 120 and the touch-sensitive panel 110 on marginal and/or peripheral areas of the display panel 120 and the touch-sensitive panel 110 and surrounds the supporting bumps 130 located in the non-marginal areas. Therefore, shape of the adhesive layer 140 can be circular. In an embodiment, thickness T1 of the adhesive layer 140 is larger than thickness T2 of each supporting bump, so a gap G1 can be formed between the display panel 120 and the touch-sensitive panel 110, which remains enough space between the display panel 120 and the touch-sensitive panel 110, so as to not be contacted to each other.

In an embodiment, when a touch-sensitive panel 110 is not subjected to oppression. for instance, the touch-sensitive panel 110 is not manipulated by a user, all supporting bumps 130 are located in the gap G1 and remain untouched with display surface 122 of the display panel 120, as shown in FIG. 1.

FIG. 2 is a cross-sectional schematic diagram of the touch-sensitive display device of FIG. 1 while its touch-sensitive panel is subjected to oppression. With reference to FIG. 2, when the user manipulates the touch-sensitive display device 100, object A1, which may be a stylus or finger, gets in touch with the touch-sensitive surface 112. During the course of the object A1 being touched with the touch-sensitive surface 112, the object A1 may oppress the touch-sensitive surface 112 sometimes so that the touch-sensitive panel 110 gets deformed, causing the possibility of the supporting bumps 130 getting in touch with the display panel 120, as shown in FIG. 2.

However, as the supporting bumps 130 have elasticity to ensure that the touch-sensitive panel 110 and the display panel 120 remain separated, the supporting bumps 130 in touch with the display panel 120 can sustain the already deformed touch-sensitive panel 110 to resist the pressure oppressed by the touch-sensitive panel 110 on the display panel 120. Therefore, the supporting bumps 130 can reduce the pressure that the display panel 120 suffers from on the display surface 122, thereby decreasing the chance of generation of pictures having non-uniform colors on the display surface 122.

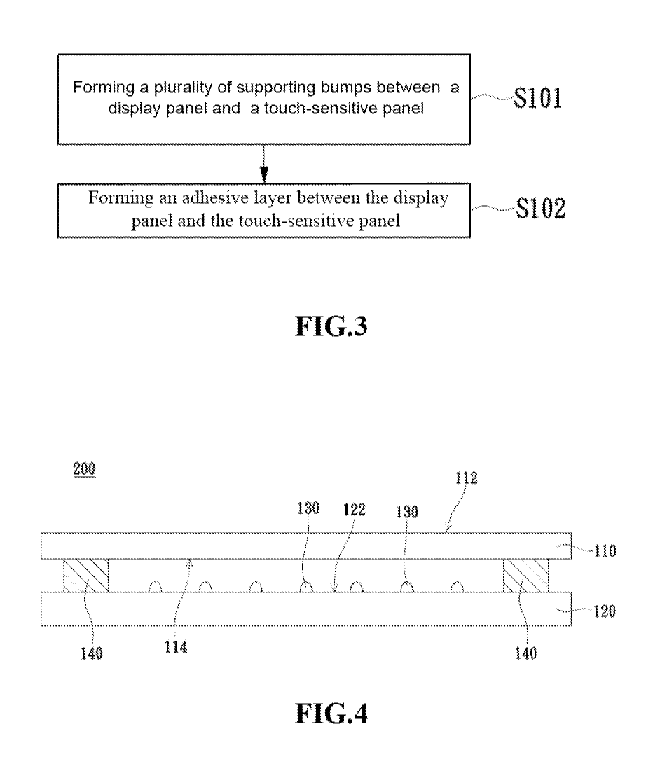

FIG. 3 is a flow-path schematic diagram of a fabricating method for a touch-sensitive display device of FIG. 1. With reference to FIG. 1 and FIG. 3 and in accordance with the fabricating method for the touch-sensitive display device 100, the method comprises forming a plurality of supporting bumps 130 between display panel 120 and touch-sensitive panel 110 (Step S101), and more specifically, the supporting bumps is between display surface 122 of display panel 120 and bottom surface 114 of touch-sensitive panel 110, wherein ways for forming the supporting bumps 130 include printing or coating.

Next, the method comprises the step of forming an adhesive layer 140 display panel 120 and touch-sensitive panel 110 (Step S102) to be applied to bond the display panel 120 and the touch-sensitive panel 110 on marginal areas of the display panel 120 and the touch-sensitive panel 110 such that the touch-sensitive display device 100 has been made in general.

FIG. 4 is the cross-sectional schematic diagram of a touch-sensitive display device in accordance with another embodiment of the present disclosure. With reference to FIG. 4, the touch-sensitive display device 200 of the present embodiment and fabricating method thereof are similar to those of the touch-sensitive display device 100 of the foregoing embodiment. The difference lies in that supporting bumps 130 in the touch-sensitive display device 200 are disposed and formed on display surface 122 of display panel 120. Moreover, the efficiency and the material of the supporting bumps 130 in the touch-sensitive display device 200 are same as those of the foregoing embodiment, which are not repeated again.

In conclusion, the present disclosure can reduce the chance of having, pictures with non-uniform colors on the touch-sensitive display device by using a plurality of supporting bumps so as to maintain and enhance picture quality of the touch-sensitive display device. Moreover, since the supporting bumps can reduce the pressure that the display panel suffers from on the display surface, enduring, capability of the touch-sensitive display device on the touch surface is enhanced and structural intensity of the touch-sensitive display device is strengthened.

While certain embodiments have been shown and described, various modifications and substitutions may be made thereto without departing from the spirit and scope of the disclosure. Therefore, it is to be understood that the present disclosure has been described by way of illustration and not limitations.

What is claimed is:

1. A touch-sensitive display device, comprising:
a display panel;
a touch-sensitive panel arranged above the display panel; and
a plurality of supporting bumps located between display panel and the touch-sensitive panel, wherein the supporting bumps have elasticity to keep the touch-sensitive panel and the display panel separated.

2. The touch-sensitive display device of claim 1, wherein the display panel has a display surface, and the touch-sensitive panel comprises of a touch-sensitive surface and a bottom surface opposite to the touch-sensitive surface, further wherein the bottom surface is face to the display surface.

3. The touch-sensitive display device of claim 2, wherein the supporting bumps are disposed on the bottom surface of the touch-sensitive panel.

4. The touch-sensitive display device of claim 2, wherein the supporting bumps are disposed on the display surface of the display panel.

5. The touch-sensitive display device of claim 1, wherein the supporting bumps are transparent or non-transparent bumps.

6. The touch-sensitive display device of claim 1, wherein the supporting bumps are mutually isolated.

7. The touch-sensitive display device of claim 1, further comprising an adhesive layer disposed between the touch-sensitive panel and the display panel, wherein the adhesive layer is applied to bond the display panel and the touch-sensitive panel on marginal areas of the display panel and the touch-sensitive panel, and wherein the adhesive layer surrounds supporting bumps located in non-marginal areas.

8. The touch-sensitive display device of claim 6, wherein thickness of the adhesive layer is larger than that of each of the supporting bumps.

9. The touch-sensitive display device of claim 1, wherein the supporting bumps are made of ultraviolet solidified ink.

10. A method for fabricating a touch-sensitive display device comprising: forming a plurality of supporting bumps between a display panel and a touch-sensitive panel, wherein the supporting bumps have elasticity to keep the touch-sensitive panel and the display panel separated.

11. The method for fabricating the touch-sensitive display device of claim 10, wherein the display panel has a display surface. and the touch-sensitive panel comprises of a touch-sensitive surface and a bottom surface opposite to the touch-sensitive surface, further wherein the bottom surface is face to the display surface.

12. The method for fabricating the touch-sensitive display device of claim 11, wherein the supporting humps are disposed on the bottom surface of the touch-sensitive panel.

13. The method for fabricating the touch-sensitive display device of claim 11, wherein the supporting bumps are disposed on the display surface of the display panel.

14. The method for fabricating the touch-sensitive display device of claim 10, wherein the supporting bumps are formed by printing or coating.

15. The method for fabricating the touch-sensitive display device of claim 10, wherein the supporting bumps are transparent or non-transparent bumps.

16. The method for fabricating the touch-sensitive display device of claim 10, wherein the supporting bumps are mutually isolated.

17. The method for fabricating the touch-sensitive display device of claim 10, further comprising forming an adhesive layer between the touch-sensitive panel and the display panel, wherein the adhesive layer is applied to bond the display panel and the touch-sensitive panel on marginal areas of the display panel and the touch-sensitive panel and surrounds the supporting bumps located in non-marginal areas.

18. The method for fabricating the touch-sensitive display device of claim 17, wherein thickness of the adhesive layer is larger than that of each of the supporting bumps.
